(19) United States
(12) Patent Application Publication
(10) Pub. No.: US 2023/0352890 A1
(43) Pub. Date: Nov. 2, 2023

(54) ELECTRICAL CONNECTOR

(71) Applicant: Acer Incorporated, New Taipei City (TW)

(72) Inventors: Yu-Shih Wang, New Taipei City (TW); Chih-Chun Liu, New Taipei City (TW); Cheng-Nan Ling, New Taipei City (TW); Wen-Chieh Tai, New Taipei City (TW)

(73) Assignee: Acer Incorporated, New Taipei City (TW)

(21) Appl. No.: 18/088,748

(22) Filed: Dec. 26, 2022

(30) Foreign Application Priority Data
Apr. 28, 2022 (TW) 111116272

(51) Int. Cl. H01R 24/60; H01R 13/6582; H01R 13/516; H01R 13/405

(52) U.S. Cl. CPC H01R 24/60; H01R 13/6582; H01R 13/516; H01R 13/405

(57) ABSTRACT

An electrical connector including an insulating body, a metal shielding member disposed in the insulating body, a plurality of terminals disposed in the insulating body, and an outer shell sheathed on the insulating body is provided. The metal shielding member has a leading edge, a pair of side edges bordered at two opposite sides of the leading edge, a protrusion located at the leading edge, and a plurality of openings. The leading and the side edges are protruded out of the insulating body. The openings are located between the leading and the side edges, and are concentrated at positions near the leading edge. Portions of the insulating body penetrate the openings.

### CROSS-REFERENCE TO RELATED APPLICATION

This application claims the priority benefit of Taiwan application serial no. 111116272, filed on Apr. 28, 2022. The entirety of each of the above-mentioned patent applications is hereby incorporated by reference herein and made a part of this specification.

### BACKGROUND

### Technical Field

The disclosure relates to an electrical connector.

### DESCRIPTION OF RELATED ART

Currently, it is very common for electronic devices to use USB cables for charging or data transmission. However, in the process of plugging and unplugging, the USB electrical connector is often collided, squeezed and damaged due to improper operation, such as improper force application or wrong docking angle.

Portable electronic devices are used in existing educational settings, such as allowing students to use tablet computers or laptops to conduct lessons. Therefore, a charging device having a plurality of fixed charging slots is correspondingly provided in a classroom or a specific location, so that these portable electronic devices can be centrally stored for charging when not in use.

However, due to the centralized arrangement of these fixed slots, each parallel charging slot does not have enough space for the user to operate, so that the portable electronic device does not have enough space for the user to hold. Therefore, when the portable electronic device is inserted into and pulled out of the fixed charging slots, the outer metal shell of the plug is likely to impact the plastic part of the slot, causing the above-mentioned damage.

### SUMMARY

The application provides an electrical connector, which improves the structural strength and impact resistance of an insulating body by means of a metal shielding member.

The electrical connector including an insulating body, a metal shielding member disposed in the insulating body, a plurality of terminals disposed in the insulating body, and an outer shell sheathed on the insulating body is provided. The metal shielding member has a leading edge, a pair of side edges bordered at two opposite sides of the leading edge, a protrusion located at the leading edge, and a plurality of openings. The leading and the side edges are protruded out of the insulating body. The openings are located between the leading and the side edges, and are concentrated at positions near the leading edge. Portions of the insulating body penetrate the openings.

Based on the above, the electrical connector enhances the structural strength of the metal shielding member disposed in the insulating body. In addition to protruding from the insulating body with the leading edge (and the protrusion) and the side edge of the metal shielding member, part of the insulating body is also made to penetrate the opening of the metal shielding member. In this way, the former is used to improve the impact resistance of the insulating body during the plugging and unplugging process of the electrical connector, and the latter can also improve the bonding strength between the insulating body, the metal shielding member and the terminal. Accordingly, the plug-and-pull strength of the relevant part when the electrical connector is used for docking with another electrical connector is improved, thereby improving the durability and service life of the electrical connector.

### BRIEF DESCRIPTION OF THE DRAWINGS

FIG. 1 is a schematic diagram of an electrical connector according to an embodiment of the application.

FIG. 2 is a side view of the configuration of the electrical connector of FIG. 1.

FIGS. 3 and 4 are respectively exploded views of the electrical connector of FIG. 1 at different levels.

FIG. 5 is a top view of some components of the electrical connector of FIG. 1.

FIG. 6 is a top view of a metal shielding member of the electrical connector of FIG. 1.

### DESCRIPTION OF THE EMBODIMENTS

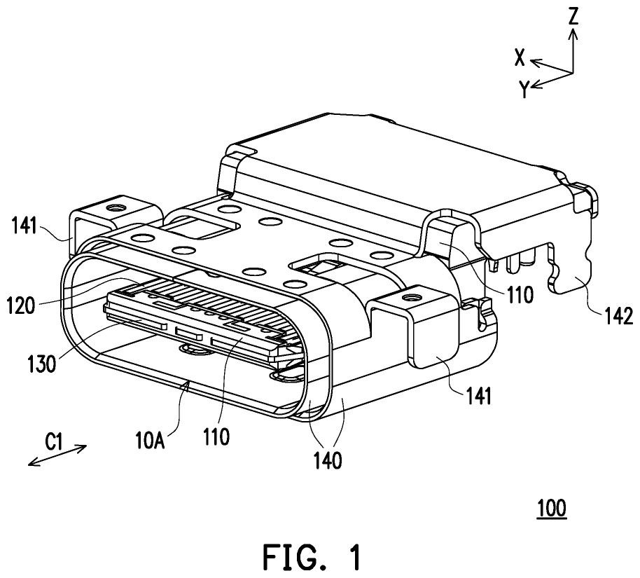

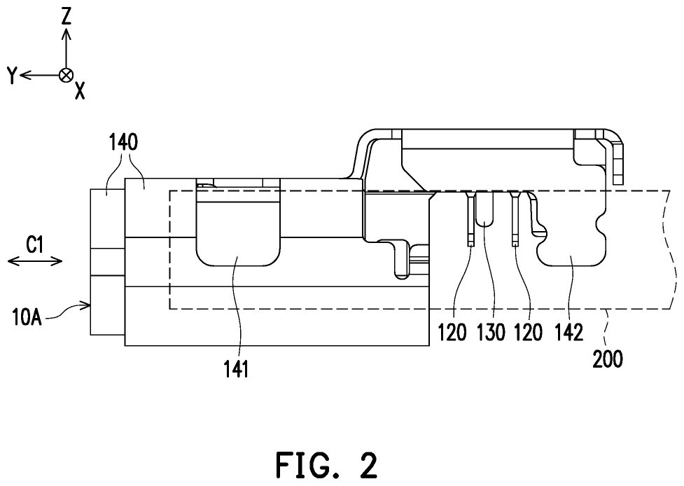

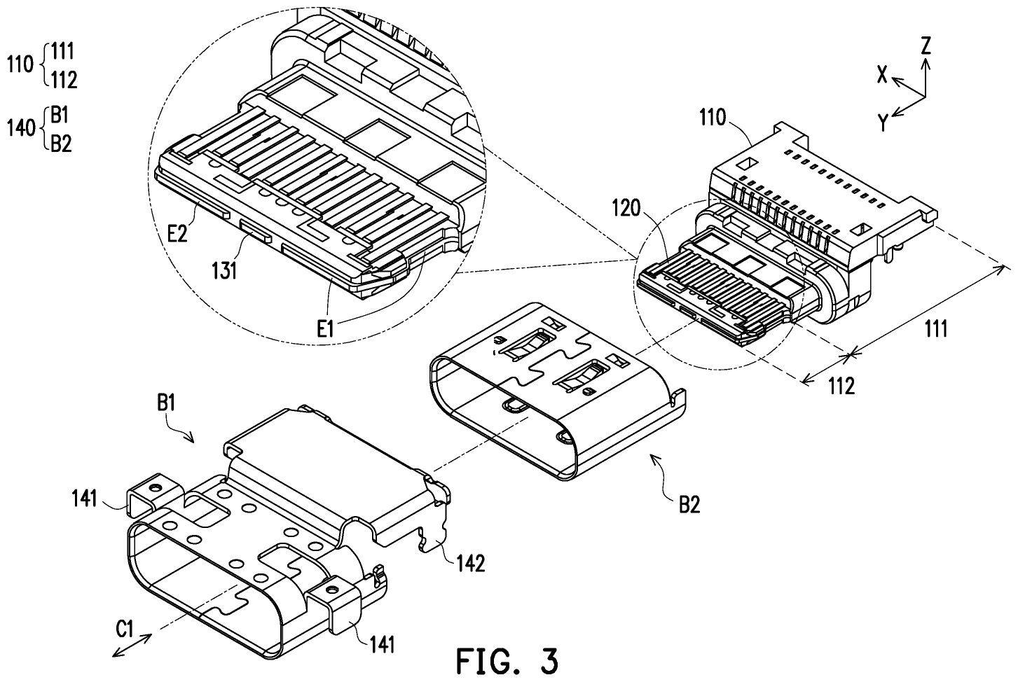

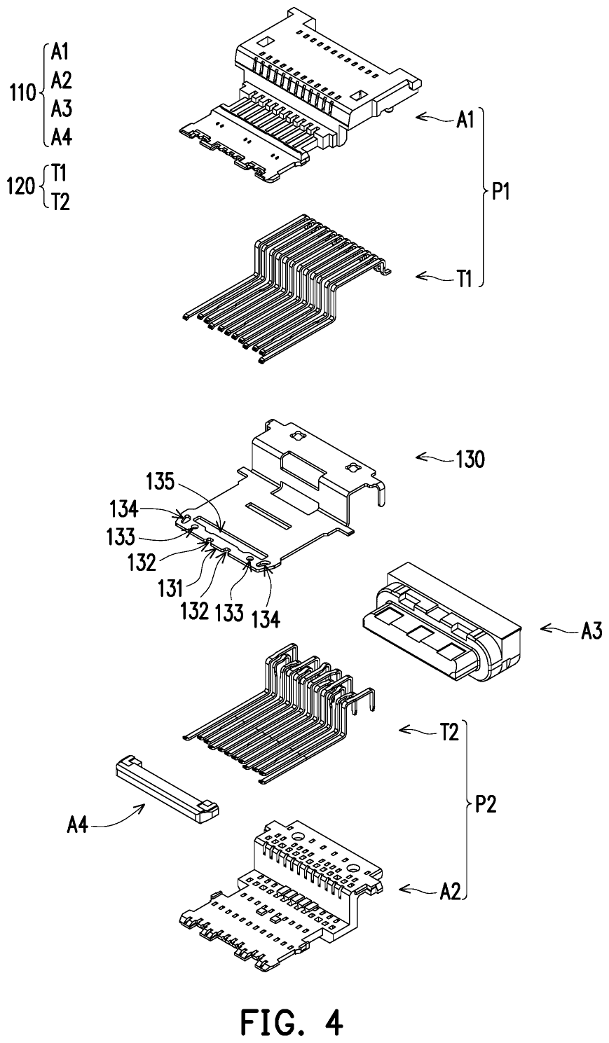

FIG. 1 is a schematic diagram of an electrical connector according to an embodiment of the application. FIG. 2 is a side view of the configuration of the electrical connector of FIG. 1. FIGS. 3 and 4 are respectively exploded views of the electrical connector of FIG. 1 at different levels. At the same time, rectangular coordinates X-Y-Z are provided to facilitate the description of components. Referring to FIG. 1 to FIG. 3 first, in the embodiment, the electrical connector 100 is, such as the electrical socket connector of USB type C, used for disposing on the circuit board 200 in the electronic device (not shown). The electrical connector 100 has an interface 10A, so as to facilitate plugging and unplugging with another electrical connector (not shown) along the docking axis C1 (parallel to the Y-axis) for docking or releasing.

Referring to FIG. 1, FIG. 3 and FIG. 4 again, in the embodiment, the electrical connector 100 includes an insulating body 110, a metal shielding member 130, a plurality of terminals 120 and an outer shell 140. The metal shielding member 130 is disposed in the insulating body 110. The insulating body 110 includes a tongue portion 112 and a stepped base portion 111, the tongue portion 112 extends from the base portion 111 toward the interface 10A along the docking axis C1. Here, the insulating body 110 is combined with the terminals 120 by inserting molding. Furthermore, the outer shell 140 includes shells B1 and B2, wherein the shell B1 has pins 141 and 142 for being inserted and positioned on the circuit board 200 and electrically connected to the ground terminal (not shown) of the circuit board 200 through soldering materials (not shown), as shown in FIG. 2.

Further, as shown in FIG. 4, in the manufacturing process of the electrical connector 100 of this embodiment, the terminals 120 are firstly divided into two groups of terminal groups T1 and T2, wherein the terminal group T1 is combined by the part A1 of the insulating body 110 to form a component P1 by inserting molding. On the other hand, the terminal group T2 is also combined by the part A2 of the insulating body 110 to form a component P2 by inserting molding. After that, the component P1, the component P2 and the metal shielding member 130 are combined with components A3 and A4 by inserting molding, so that the terminal groups T1 and T2 are arranged up and down relative to the metal shielding member 130 to be separated. Finally, as shown in FIG. 3, the shell B2 and the shell B1 of the outer shell 140 are sequentially sheathed on the insulating body 110, so that the insulating body 110, the terminals 120 and the metal shielding member 130 are surrounded and housed inside the outer shell 140. At this point, the manufacturing of the electrical connector 100 is completed.

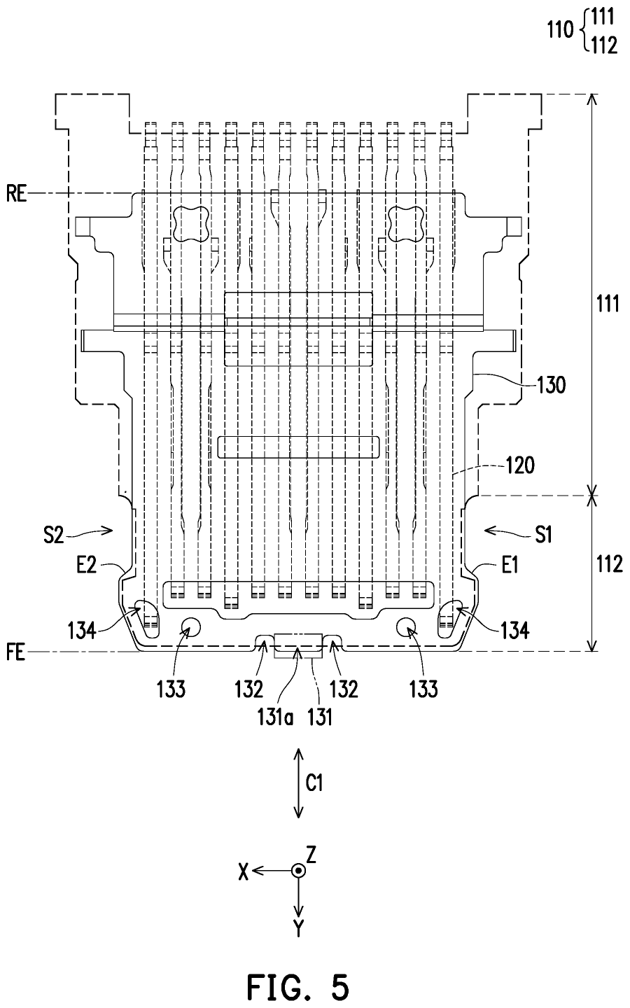

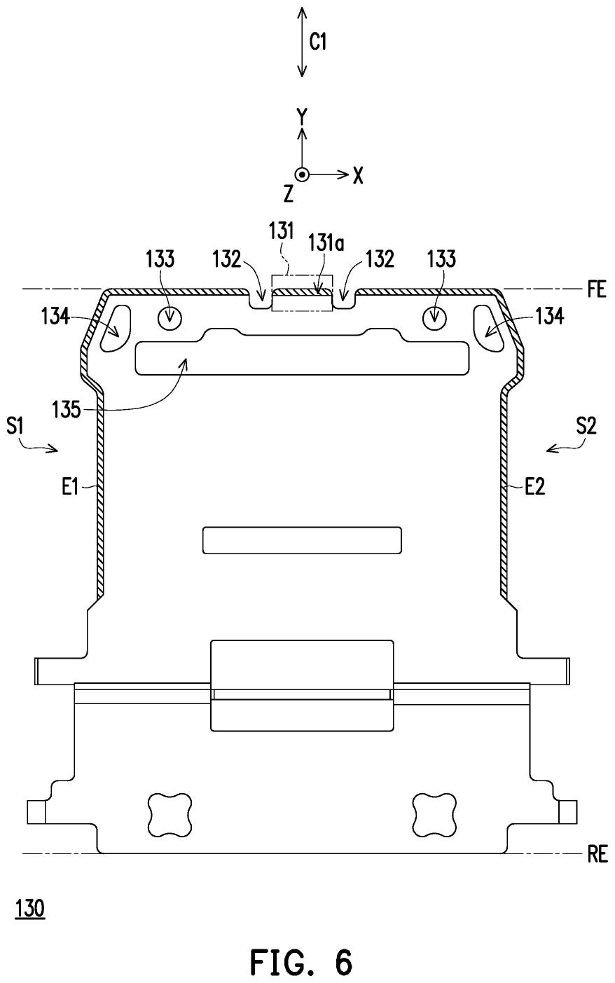

FIG. 5 is a top view of some components of the electrical connector of FIG. 1. Here, the insulating body 110 and the terminals 120 are shown with dotted lines, and the metal shielding member 130 is shown with solid lines, so as to facilitate the identification of the corresponding relationship between the components. FIG. 6 is a top view of a metal shielding member of the electrical connector of FIG. 1, which can be viewed in comparison with FIG. 5. Referring to FIG. 4 to FIG. 6 at the same time, in this embodiment, the metal shielding member 130 has a protrusion 131, a plurality of openings (which is divided into a first opening 133, a second opening 134 and a lateral opening 135), a leading edge FE, a trailing edge RE and a pair of side edges S1, S2, wherein the protrusion 131 is located at the leading edge FE. The side edges S1, S2 is bordered at two opposite sides of the leading edge FE. The leading edge FE and the side edges S1 and S2 protrude out of the insulating body 110. The openings are located between the leading edge FE and the side edges S1, S2 and are concentrated at positions near the leading edge FE, and portions of the insulating body 110 penetrate the openings.

As mentioned above, the insulating body 110 is divided into the tongue portion 112 and the base portion 111 along the Y-axis and the leading edge FE and the side edges S1 and S2 of the metal shielding member 130 are exposed from the tongue portion 112. As shown in FIG. 1 or FIG. 2, the metal shielding member 130 protruding from the insulating body 110 is shown as portions E1, E2 and 131a, and the regions are marked in FIG. 6 for easy identification. In this way, when the electrical connector 100 is mated with the other electrical connector, these portions E1, E2 and 131a can be used as opponent structures when mating with the other electrical connector (the aforementioned plug). In other words, the existing electrical connector uses the insulating body as the opponent structure when the other electrical connector is docked, so that the insulating body is easily damaged due to the collision between the insulating body of plastic material and the metal shell of the other electrical connector. On the contrary, in the electrical connector 100 of the embodiment, a part of the metal shielding member 130 protrudes from the insulating body 110, and the protruding part is the area where the electrical connector 100 and the other electrical connector are likely to collide. Therefore, the part of the metal shielding member 130 protruding from the insulating body 110 can replace the insulating body 110 and become the opponent structure when the other electrical connector is butted, so as to improve the structural strength of the electrical connector 100 at the tongue portion 112.

In the embodiment, the aforementioned portion 131a is the portion where the protrusion 131 protrudes from the insulating body 110, wherein the preferred size of the protrusion 131 along the leading edge FE (that is, the size of the protrusion 131 along the X-axis) is 1.0±0.1 mm. At the same time, the metal shielding member 130 further has a pair of notches 132 at the leading edge FE, abutting on opposite sides of the protrusion 131. Here, the notch 132 is used to facilitate the metal shielding member 130 to be cut off from the material strip during the stamping process of the plate. In other words, during the manufacturing process of the metal shielding member 130, the protrusion 131 is used as the connection point with the material tape, so the notches 132 provide the operating space required for punching and cutting the metal shielding member 130 from the material tape.

As shown in the aforementioned manufacturing process shown in FIG. 4, in the process of combining the components P1, P2 and the metal shielding member 130, it is precisely because the metal shielding member 130 has the above-mentioned opening that inserting molding can be used to pass the portion of the part A4 through the opening to firmly combine the components P1, P2 and the metal shielding member 130 together.

It is worth mentioning that, in addition to the above-mentioned requirements for combining the components P1 and P2, the metal shielding member 130 also has the following features to improve its structural strength. Details are as follows: the openings of the embodiment includes a pair of first openings 133, a pair of second openings 134 and a lateral opening 135. The pair of first openings 133 are located on opposite sides of the protrusion 131 along the X-axis. The pair of second openings 134 are located on opposite sides of the protrusion 134 along the X-axis. The distance of each of the first openings 133 relative to the protrusion 131 is smaller than the distance of each of the second openings 134 relative to the protrusion 131. And the pair of first openings 133 are located between the leading edge FE and the lateral opening 135. In the embodiment, each of the first openings 133 is a circular hole with a diameter of 0.35 mm. Each of the second openings 134 is a reaming hole with an area of 0.22 mm², and the expansion direction of reaming hole is consistent with part of the side edges S1, S2.

In other words, the above-mentioned features about the openings (the first opening 133, the second opening 134, and the lateral opening 135) are to satisfy both the structural strength of the metal shielding member 130 and its bonding strength with the part A4. Therefore, except for the necessary (combined) openings, the metal shielding member 130 essentially excludes other unnecessary openings. Furthermore, in order to optimize the structural strength of the metal shielding member 130, the physical structure size of the metal shielding member 130 between the leading edge FE and the lateral opening 135 is further consistent with the physical structure size of the metal shielding member 130 between the side edges S1, S2 and the lateral opening 135 (equivalent to the minimum relative distance from the edge of the lateral opening 135 to the leading edge FE along the Y axis, and the minimum relative distance from the edge of the lateral opening 135 to the side edge S1 or side edge S2 along the X-axis), and is consistent with the physical structure size around the second opening 134. In particular, the metal shielding member 130 is formed by bending and punching metal plates of equal thickness. Here, the size of the physical structure around the second opening 134 is greater than or equal to twice the thickness of the metal shielding member 130. The size of the physical structure around the first opening 133 is greater than or equal to twice the thickness of the metal shielding member 130, so as to ensure that the structural strength of the metal shielding member 130 is not weakened by these openings. As shown in FIG. 6, the metal shielding member 130 still has a lateral opening at the center and a lateral opening near the trailing edge RE. As shown in FIG. 4, the lateral opening near the trailing edge RE is used to allow the passage of part A3 during inserting molding, and the aforementioned lateral opening at the center is not used for the insulating body 110 to penetrate, but is used as the metal shielding member 130 to relieve its own internal stress during the stamping and bending process.

On the other hand, referring to FIG. 5 and FIG. 6 at the same time, the embodiment still needs to consider the bonding relationship between the metal shielding member 130, the terminals 120 and the insulating body 110. Here, as shown in FIG. 5, the orthographic projection of the ends of a plurality of ground terminals (which is the most side terminal in terminal group T1 or terminal group T2) of the terminals 120 on the metal shielding member 130 are respectively seated in the second openings 130 the terminals 120, the orthographic projection of the ends of the other terminals except the ground terminals on the metal shielding member 130 is seated in the lateral opening 135. In other words, combined with the above process description about inserting molding, the part A4 of the insulating body 110 is used to penetrate the opening (the first opening 133, the second opening 134 and the lateral opening 135) to join the ends of the terminals 120 together, which can effectively solve the warping problem of the ends of the terminals 120 during the manufacturing process. At the same time, the orthographic projections of the ends of the terminals 120 on the metal shielding member 130 are located in these openings to avoid short circuits due to contact with the metal shielding member 130, so as to comply with safety regulations.

To sum up, in the above-described embodiments of the application, the electrical connector enhances the structural strength of the metal shielding member disposed in the insulating body. In addition to protruding from the insulating body with the leading edge (and the protrusion) and the side edge of the metal shielding member, part of the insulating body is also made to penetrate the opening of the metal shielding member. In this way, the former is used to improve the impact resistance of the insulating body during the plugging and unplugging process of the electrical connector, and the latter can also improve the bonding strength between the insulating body, the metal shielding member and the terminal. Accordingly, the plug-and-pull strength of the relevant part when the electrical connector is used for docking with another electrical connector is improved, thereby improving the durability and service life of the electrical connector.

What is claimed is:

1. An electrical connector, comprising:
an insulating body;
a metal shielding member, disposed in the insulating body, the metal shielding member has a protrusion, a plurality of openings, a leading edge and a pair of side edges, wherein the protrusion is located at the leading edge, the side edges is bordered at two opposite sides of the leading edge, the leading and the side edges are protruded out of the insulating body, the openings are located between the leading edge and the side edges and are concentrated at positions near the leading edge, and portions of the insulating body penetrate the openings;
a plurality of terminals, disposed in the insulating body, the metal shielding member separates the terminals into two terminal groups arranged up and down, and orthographic projection of the ends of the terminals on the metal shielding member are seated on part of the openings; and
an outer shell, sheathed on the insulating body.

2. The electrical connector according to claim 1, wherein the metal shielding member further has a pair of notches at the leading edge, abutting on opposite sides of the protrusion.

3. The electrical connector according to claim 1, wherein the dimension of the protrusion along the leading edge is 1.0±0.1 mm.

4. The electrical connector according to claim 1, wherein the openings are independent from each other.

5. The electrical connector according to claim 1, wherein the openings include a pair of first openings, a pair of second openings and a lateral opening, the pair of first openings are located on opposite sides of the protrusion, the pair of second openings are located on opposite sides of the protrusion, the distance of each of the first openings relative to the protrusion is smaller than the distance of each of the second openings relative to the protrusion, the pair of first openings are located between the leading edge and the lateral opening.

6. The electrical connector according to claim 5, wherein each of the first openings is a circular hole with a diameter of 0.35 mm.

7. The electrical connector according to claim 5, wherein each of the second openings is a reaming hole with an area of 0.22 mm².

8. The electrical connector according to claim 7, wherein the expansion direction of the reaming hole is consistent with part of the side edges.

9. The electrical connector according to claim 5, wherein the orthographic projection of the ends of a plurality of ground terminals of the terminals on the metal shielding member are respectively seated in the second openings.

10. The electrical connector according to claim 5, wherein the orthographic projection of the ends of the other terminals except the ground terminals on the metal shielding member is seated in the lateral opening.

11. The electrical connector according to claim 5, wherein a physical structural dimension of the metal shielding member between the leading edge and the lateral opening is the same as a physical structural dimension of the metal shielding member between the side edge and the lateral opening.

12. The electrical connector according to claim 5, wherein the size of the physical structure of the metal shielding member around the second opening is consistent.

13. The electrical connector according to claim 1, further comprise an interface to be butted with another electrical connector along a docking axis, wherein the insulating body comprises a tongue portion and a stepped base portion, the tongue portion extends from the base portion toward the interface along the docking axis, and the leading edge and the pair of side edges protrude from the tongue portion from the insulating body.

14. The electrical connector according to claim 5, wherein the metal shielding member is a plate of equal thickness, and the size of the physical structure around the second opening is greater than or equal to twice the thickness of the metal shielding member.

15. The electrical connector according to claim 5, wherein the metal shielding member is a plate of equal thickness, and the size of the physical structure around the first opening is greater than or equal to twice the thickness of the metal shielding member.

16. The electrical connector according to claim 1, wherein the insulating body is combined with the terminals by inserting molding, and part of the insulating body penetrates the openings.
